(19) United States
(12) Patent Application Publication
(10) Pub. No.: US 2024/0251284 A1
(43) Pub. Date: Jul. 25, 2024

(54) SIDELINK END-TO-END QUALITY OF SERVICE SPLIT REPORTING

(71) Applicant: Dell Products, L.P., Round Rock, TX (US)

(72) Inventor: Ali Esswie, Montreal (CA)

(21) Appl. No.: 18/157,439

(22) Filed: Jan. 20, 2023

(51) Int. Cl. H04W 28/02; H04W 24/10

(52) U.S. Cl. CPC H04W 28/0268; H04W 24/10

(57) ABSTRACT

A source user equipment transmits to a primary user equipment of a sidelink communication group an end-to-end quality-of-service report request requesting one or more performance parameter metrics. The primary user equipment transmits partial quality-of-service report requests comprising requests for the metrics to user equipment of the sidelink group that make up a communication path to a destination user equipment. The sidelink user equipment determine the parameter metrics corresponding to links of the sidelink communication path and transmit indications of the metrics to the primary user equipment as partial quality-of-service reports. The primary user equipment compiles, and transmits to the source user equipment, an end-to-end quality-of-service report based on the partial quality-of-service reports. The source user equipment tunes transmission of traffic to the destination user equipment according to the end-to-end quality-of-service report. Sidelink subgroups may report to the primary user equipment partial quality-of-service reports corresponding to the subgroup.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., may permit higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

Sidelink communications may facilitate a variety of cellular use-cases such as autonomous vehicle crash avoidance, public avoidance, coordinated vehicle cruise control, and the like, where devices become able to communicate and coordinate directly with each other without communication messaging and signaling going through the RAN network. This may be helpful in cases where some of or all user equipment that coordinate as part of a sidelink group are located beyond RAN wireless coverage. User equipment devices may also communicate with one another via short-range wireless communication links other than sidelink communication links, such as, for example, Wi-Fi, Bluetooth, and the like.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method comprises receiving, from a source user equipment by a primary user equipment, which may be referred to as a primary relay user equipment, comprising a processor, a request for an end-to-end quality-of-service report corresponding to a destination secondary user equipment. The primary user equipment may be part of a sidelink group of user equipment that comprises secondary user equipment, which may be referred to as secondary relay user equipment or intermediate relay user equipment. A member of the sidelink group may be capable of communication with another member of the sidelink group via a short-range communication link, such as a sidelink link, a Wi-Fi link, or a Bluetooth link. The primary user equipment may be capable of communication with the source user equipment via a short-range communication link. A secondary user equipment of the sidelink group may be capable of communicating with the destination user equipment via a short-range communication link. The group of sidelink user equipment, and short-range communication links, may compose, make up, a communication path from the source user equipment to the destination user equipment, which may not be able to communication directly with the source user equipment (e.g., the source user equipment and the destination user equipment may not be able to establish a communication link that directly connects the source user equipment and the destination user equipment without an intervening user equipment or communication link corresponding to the intervening user equipment). Thus, the sidelink group of user equipment may relay traffic directed to the destination user equipment from the source user equipment via communication links that connect the user equipment members of the sidelink group, which members may be referred to as relay user equipment (e.g., a primary relay user equipment or secondary/intermediate user equipment).

The example method may further comprise transmitting, by the primary user equipment to a first intermediate secondary user equipment (e.g., a first intermediate relay user equipment), a first partial quality-of-service report request requesting a first quality-of-service parameter metric corresponding to a first communication link. The example method may further comprise receiving, from the first intermediate secondary user equipment by the primary user equipment, responsive to the first partial quality-of-service report request, a first partial quality-of-service report comprising a first quality-of-service parameter metric indication indicative of the first quality-of-service parameter metric corresponding to the first communication link. The example method may further comprise transmitting, by the primary user equipment to the source user equipment, responsive to the request for the end-to-end quality-of-service report, the end-to-end quality-of-service report comprising the first quality-of-service parameter metric indication, or an indication based on the first quality-of-service parameter metric indication. The end-to-end quality-of-service report may be based on the first quality-of-service parameter metric and may comprise an end-to-end parameter metric indicative of overall quality of the communication path between the source user equipment and the destination user equipment. The primary user equipment, the first intermediate secondary user equipment, and the destination secondary user equipment may be members of a sidelink group of user equipment.

In an embodiment, the example method may further comprise receiving, by the primary user equipment from the source user equipment, a portion of traffic that is directed to the destination secondary user equipment based on the end-to-end quality-of-service report.

The first quality-of-service parameter metric may comprise one of: a Packet Error Rate or a Packet Delay Budget. The request for the first partial quality-of-service report may comprise a parameter index (e.g., index values 230 shown in FIG. 2) indicative of a combination of one or more parameter metrics, or indicative of a request therefor, of a configured set of parameter metrics (e.g., metrics corresponding to parameters 235 shown in FIG. 2).

In an embodiment, the example method may comprise determining, by the primary user equipment, an intermediate user equipment set of secondary user equipment to be used to relay at least a portion of traffic from the source user equipment to the destination secondary user equipment. The intermediate user equipment set may be referred to as a subset, or a subgroup, of user equipment, such as, for example, subgroup 312 shown in FIG. 3. The request for the first partial quality-of-service report may request a combined, or composite, parameter metric report corresponding to the first communication link and one or more communication links corresponding to one or more intermediate user equipment of the intermediate user equipment set.

In an embodiment, the request may be a first request, and the example method may further comprise transmitting, by the primary user equipment directed to a second intermediate secondary user equipment, a second request for a second partial quality-of-service report requesting at least one quality-of-service parameter metric corresponding to a second communication link, wherein the first partial quality-of-service report is based on the second partial quality-of-service report comprising a second parameter metric indication indicative of a second quality-of-service parameter metric corresponding to the second communication link. In an embodiment, the example method may further comprise determining, by the primary user equipment, a second intermediate secondary user equipment, as a member of the intermediate user equipment set, or as a member of an intermediate user equipment subset, to be used to relay at least the portion of traffic from the source user equipment to the destination secondary user equipment via a second communication link.

In an embodiment, the request may be a first request, and the example method may further comprise transmitting, by the primary user equipment directed to the second intermediate secondary user equipment, a second request for a second partial quality-of-service report requesting a second quality-of-service parameter metric corresponding to a second communication link. The primary user equipment may receive, responsive to the second request for the second partial quality-of-service report, the second partial quality-of-service report comprising a second quality-of-service parameter metric indication indicative of the second quality-of-service parameter metric. The end-to-end quality-of-service report may comprise a combined, or composite, metric indication that is a function of at least one of the first quality-of-service parameter metric or the second quality-of-service parameter metric. For example, the function may be to multiply the first quality-of-service parameter metric and the second quality-of-service parameter metric. In another example, the function may be to sum the first quality-of-service parameter metric and the second quality-of-service parameter metric.

In an embodiment, the example method may further comprise receiving, by the primary user equipment from the source user equipment, at least a portion of traffic that is directed to the destination secondary user equipment based on the composite metric indication. Thus, the primary user equipment may synthesize reported metrics indicated by multiple partial quality-of-service reports received from secondary user equipment of a sidelink group. One or more of the partial quality-of-service reports may be synthesized at a given secondary user equipment from one or more partial quality-of-service reports that may be based on partial quality-of-service reports received from other secondary user equipment of the sidelink group. The primary user equipment may transmit, synthesized from the partial quality-of-service report into an end-to-end quality-of-service report, that is indicative of performance of links of the sidelink communication path between the source user equipment and the destination user equipment. The source user equipment, after receiving the end-to-end quality-of-service report may transmit traffic, or a portion of traffic (e.g., a packet, a frame, a slot, a minislot, etc.), to the destination user equipment via communication links joining user equipment of a sidelink communication group according to the end-to-end quality-of-service report.

In an example user equipment embodiment, a first user equipment, may comprise a processor configured to: receive a subset indication indicative of a determined subset of nodes of a communication path usable to carry traffic directed from a source user equipment to a destination user equipment, wherein the communication path comprises a first communication link between a first node and a second node of the determined subset of nodes, and wherein the first user equipment corresponds to the first node. The first user equipment may be a secondary relay user equipment of a sidelink group that makes up a communication path between the source user equipment and the secondary user equipment.

The processor of the example first user equipment may be further configured to receive a first request for a first partial quality-of-service report requesting at least one quality-of-service metric corresponding to the first communication link. The processor may be further configured to receive a remote partial quality-of-service report. The remote partial quality-of-service report be transmitted, by a second user equipment that corresponds to the second node, in response to a second request for a second partial quality-of-service report. The request for the second partial quality-of-service report may request at least one quality-of-service metric corresponding to a second communication link, of the communication path, corresponding to the second user equipment. The remote partial quality-of-service report may comprise a second metric indication indicative of a second quality-of-service metric corresponding to the second communication link. The processor of the first user equipment may be further configured to combine a first quality-of-service metric of the at least one quality-of-service metric corresponding to the first communication link and the second quality-of-service metric to result in a combined partial quality-of-service report. The processor of the first user equipment may be further configured to transmit the combined partial quality-of-service report to the source user equipment.

In an embodiment, the first request for the first partial quality-of-service report may comprise a request for the combined partial quality-of-service report corresponding to the determined subset of nodes. The combined partial quality-of-service report may be transmitted, by the first user equipment, to the primary user equipment. The determined subset of nodes may comprise the first user equipment, the second user equipment, and the primary user equipment, or the first user equipment and the second user equipment, which may be secondary relay user equipment. In an embodiment, the first user equipment, the second user equipment, and the primary user equipment may be part of a sidelink group of user equipment. In an embodiment, the processor of the first user equipment may be further configured to transmit, to the source user equipment, an end-to-end quality-of-service report comprising an end-to-end quality-of-service indication indicative of an end-to-end quality-of-service of an end-to-end communication path between the source user equipment and the destination user equipment, and wherein the end-to-end quality-of-service report comprises the combined partial quality-of-service report or information synthesized therefrom. In an embodiment, the combining of the first quality-of-service metric and the second quality-of-service metric may comprise applying a defined function to the first quality-of-service metric and second quality-of-service metric to result in the combined partial quality-of-service report.

In an example embodiment, a non-transitory machine-readable medium may comprise executable instructions that, when executed by a processor of a primary relay user equipment, facilitate performance of operations, comprising receiving, from a source user equipment, an end-to-end quality-of-service report request corresponding to an end-to-end quality-of-service between the source user equipment and a destination user equipment, wherein the primary relay user equipment, the destination user equipment, and at least a first intermediate relay user equipment are members of a remote group, or sidelink group, of user equipment. In the remote/sidelink group, the first intermediate relay user equipment and the destination user equipment may be beyond a long-range communication range or a short-range communication range of the source user equipment. The primary relay user equipment and the first intermediate relay user equipment may communicate via a first short-range communication link, and the first intermediate relay user equipment and the destination user equipment may communicate via a second short-range communication link. The operations may further comprise transmitting, to the first intermediate relay user equipment, a first partial quality-of-service report request requesting at least one quality-of-service parameter metric corresponding to the second short-range communication link. The operations may further comprise receiving, from the first intermediate relay user equipment, responsive to the first partial quality-of-service report request, a first partial quality-of-service report comprising a first metric indication indicative of a first quality-of-service metric corresponding to the second short-range communication link. The operations may further comprise transmitting, responsive to the end-to-end quality-of-service report request, to the source user equipment, an end-to-end quality-of-service report comprising a group quality-of-service metric indication that is indicative of a group quality-of-service corresponding to the remote group of user equipment and that is based on the first quality-of-service metric.

In an embodiment, the remote group of user equipment may comprise the first intermediate relay user equipment and a second intermediate relay user equipment. The first intermediate relay user equipment and the second intermediate relay user equipment may be communicatively linked via the second short-range communication link, and the second intermediate relay user equipment may communicate with the destination user equipment via a third short-range communication link. The first partial quality-of-service report may comprise a second metric indication indicative of a second quality-of-service metric corresponding to the third short-range communication link, and the group quality-of-service metric indication may be based on the first quality-of-service metric and the second quality-of-service metric.

In an embodiment, the first intermediate relay user equipment and the second intermediate relay user equipment may compose, or make up, a first relay subgroup of the remote group of user equipment. The remote group of user equipment may comprise a second relay subgroup comprising a third intermediate relay user equipment, wherein the second intermediate relay user equipment and the third intermediate relay user equipment are communicatively linked via the third short-range communication link. The third intermediate relay user equipment may be configured to communicate with the destination user equipment via a fourth short-range communication link. In an embodiment, the operations may further comprise transmitting, to the third intermediate relay user equipment, a second partial quality-of-service report request requesting at least one quality-of-service parameter metric corresponding to the second relay subgroup. The operations may further comprise receiving, from the third intermediate relay user equipment, responsive to the second partial quality-of-service report request, a second partial quality-of-service report comprising a third metric indication indicative of a third quality-of-service metric corresponding to the second relay subgroup, wherein the group quality-of-service metric is based on the first quality-of-service metric, the second quality-of-service metric, and the third quality-of-service metric. In an embodiment, the first short-range communication link, the second short-range communication link, the third short-range communication link, or the fourth short-range communication link may be, respectively, a sidelink communication link, a Wi-Fi communication link, or other type of short-range communication link.

### BRIEF DESCRIPTION OF THE DRAWINGS

FIG. 1 illustrates wireless communication system environment.

FIG. 2 illustrates an example environment with relay user equipment to implement split reporting of communication link metrics.

FIG. 3 illustrates an example environment with intermediate user equipment to determine a communication link metrics.

FIG. 4 illustrates a timing diagram of an example method to facilitate split reporting of communication link metrics.

FIG. 5 illustrates a flow diagram of an example method to facilitate split reporting of communication link metrics.

FIG. 6 illustrates a block diagram of an example method.

FIG. 7 illustrates a block diagram of an example user equipment.

FIG. 8 illustrates a block diagram of an example non-transitory machine-readable medium.

FIG. 9 illustrates an example computer environment.

FIG. 10 illustrates a block diagram of an example wireless UE.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

The PDCCH of a 5G NR system may deliver downlink and uplink control information to cellular devices. Compared to the control channel design of the fourth generation (e.g., LTE), the 5G control channel can match requirements of the URLLC and eMBB use cases and can offer an efficient coexistence between those different QoS classes.

The 5G PDCCH channel, unlike the Fourth-Generation control channel, may be beamformed using favored-channel vectors of each UE, with embedded demodulation-assisting demodulation reference signals (“DMRS”). The PDCCH may be modulated by a fixed QPSK modulation scheme and with a conservative coding rate such as the reliability of receiving the PDCCH channel at a UE device is maximized. For example, to satisfy a URLLC 10e−5 reliability level, the PDCCH channel decoding ability may be enhanced at the device end.

The resource size of each PDCCH channel, which may be carrying the downlink control information (“DCI”) of one or more UEs, may be time-varying, and may be referred to as PDCCH aggregation level. In particular, and to enhance PDCCH decoding, the network may increase the resource size of the PDCCH channel and accordingly adopt a more conservative and resource-less-efficient coding rate of the PDCCH. This implies that same amount of PDCCH control information is transmitted with a stronger coding rate (i.e., more redundant bits for error detection and correction) at the expense of consuming more channel resources for transmitting the PDCCH information.

There are two types of PDCCH channels. First, the UE-specific PDCCH, where a set channel resources are periodically monitored by a single UE/device. After being configured, the device will attempt to blindly decode those candidate resources in case they may be potentially carrying DCI information. This DCI information includes configurations on scheduled uplink or downlink grants, transmission configurations, and information on common system signaling and updates. Furthermore, the blind decoding is the process when the UE attempts decoding the DCI with all possible transmission configurations and aggregation levels. This implies a heavy power consumption on the device end; however, it is necessary because the UE is not yet aware about the actual configurations of the PDCCH channel and corresponding transmissions. It shall be aware of such after it successfully decodes the PDCCH. In the active mode, the UE may monitor the configured one or more PDCCH search spaces, where a search space implies a set of candidate resources that may carry the PDCCH/DCI information. The search space definitions may be used to refer to varying size of the PDCCH channel (i.e., aggregation levels) and hence, the required size of resources to carry the PDCCH may vary.

Common PDCCH search spaces are monitored by all UEs. Those common PDCCH channels typically carry DCI information that are relevant to all devices. Examples include system updates and control information, all-UE power control information, and general system information.

For each scheduled downlink or uplink transmission, there typically is a preceding PDCCH control transmission informing the UE device about resources scheduled by the network for the transmission, and transmission configurations to use for transmission in the uplink or reception in the downlink. Accordingly, the PDCCH transmissions are considered as signaling overhead, which should be always minimized, and needed for successful device transmission and/or reception.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘anything reality’ (“XR”) services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to 5 Mbps URLLC link with a 1 ms radio budget, some XR applications need 100 Mbps links with a couple of milliseconds of the allowed radio latency. Thus, 5G radio design and associated procedures may be adapt to the new XR QoS class and associated targets.

XR service may be facilitated by traffic having certain characteristics associated with the XR service. For example, XR traffic may typically be periodic with time-varying packet size and packet arrival rate. In addition, different packet traffic flows of a single XR session may affect an end user's experience differently. For instance, a smart glass that is streaming 180-degree high-resolution frames may use a large percentage of a broadband service's capacity for fulfilling user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at XR capable device is desirable. Accordingly, a user equipment device accessing XR services, or traffic flows of an XR session, may be associated with certain QoS metrics to satisfy performance targets of the XR service in terms of perceived data rate or end to end latency and reliability, for example.

Sidelink communications refers to cellular devices communicating with each other directly, without having to go through a serving RAN node, by establishing a sidelink communication link. However, a RAN node may or may not control how sidelink resources are being reserved and dictated by different sidelink devices. In one sidelink radio resource management option, sidelink devices are configured to always request a sidelink resource towards another sidelink device from the serving RAN node. This requires that at least, the transmitting sidelink node to be within the coverage of the serving node. Furthermore, the sidelink-experienced communication latency clearly increases due to the additional transmission of the RAN scheduling request and reception of the corresponding scheduling grant before the sidelink scheduling and transmission are triggered. Advantageously, this reduces the possibility of sidelink channel collisions.

In another radio resource management option, sidelink devices are configured to autonomously sense the sidelink channel resources, determine which sidelink resource are reserved for other devices' sidelink transmissions, and determine which resource set is free/available for their own transmission. The channel sensing rules and high-level channel sensing configurations are indicated from the RAN network. Therefore, the sidelink control channel has been designed to support efficient channel sensing over the sidelink interface. In particular, the sidelink control channel is designed in a two-stage format. The first stage carries a first stage sidelink control information (“SCI”) and the second stage carries a second stage SCI.

The first stage SCI is similar to the RAN downlink control information (“DCI”) and may carry the following information elements: scheduling information of a reserved data resource for a sidelink transmission of interest, and scheduling resource information of the second stage SCI that carries the transmission-specific configuration of the sidelink data channels.

Accordingly, sidelink devices attempt blindly decoding of the first stage SCI to determine which sidelink data resource will be reserved by which sidelink device in proximity. However, the sensing sidelink device cannot determine whether an actual sidelink data payload is destined for it, thus a sidelink device decodes the second stage SCI. The second stage SCI carries the following information elements: source device and destination device identifiers of the sidelink transmission, and sidelink transmission configurations including modulation schemes, coding schemes, and HARQ feedback information.

Therefore, a sidelink device monitors and blindly decodes the first stage SCI to determine the reserved channel resources for the associated sidelink transmission, determines transmission configurations of the second stage SCI, and decodes the second stage SCI to determine if a corresponding sidelink transmission is destined for it. If a sidelink device is a transmit-only device (e.g., an M2M device), the device need only receive and blindly decode the first stage SCI, while skipping decoding of the second stage SCI, in which case channel sensing may only comprise monitoring, detection, and blind decoding of the first stage SCI.

There are two modes of channel sensing. First, continuous channel sensing may be configured such that a control channel of the sidelink interface signaling can flexibly be placed at any time instant such that a sensing sidelink device needs to always search and monitor for a control channel that is carrying the first stage SCI. Second, and due to the significant power consumption burden of the continuous sensing, a partial channel sensing procedure may be implemented, such that the sidelink control channel is configured to be periodically, or non-periodically, transmitted during predefined time instants, and accordingly, sensing sidelink device need only monitor and blindly decode those timing and frequency instants while possibly deep sleeping otherwise.

Sidelink relays are sidelink devices that are performing sidelink and RAN functions on behalf of, or for the sake of, other remote sidelink devices in proximity to the sidelink relay. Sidelink relays offers a wide set of sidelink functions for remote sidelink devices including channel granting, multi-hop traffic relaying, or paging monitoring. Thus, less capable sidelink remote devices obtain several performance advantages such as power saving gains, and sidelink and RAN network coverage extension. Accordingly, there are two modes which a sidelink relay device may adopt for announcing their presence for remote devices in proximity. In one variant, sidelink relays explicitly announce their presence using a preconfigured discovery procedure. During the configured discovery period, sidelink relay broadcasts an announcement message that indicates their presence and their associated relaying configurations. Remote devices receive a relay's discovery messages and, upon interest in becoming part of, or a member of, a sidelink zone, or group, that includes the relay, initiate a direct communication link with the sidelink relay.

In another discovery variant, a sidelink remote device proactively transmits a discovery message requesting that sidelink relays in proximity announce their presence and corresponding relaying services. This option offers the advantage of the on-demand discovery signaling where sidelink relays avoid transmitting unnecessary discovery messages that may not be utilized by present remote devices in proximity.

Layer-2 relaying denotes that the end-to-end protocol stack and QoS targets over sidelink interface will not be interrupted at the relay, e.g., the relay alters lower layer headers to perform traffic relaying. Thus, with layer-2 relays, the end-to-end QoS and flows can be tracked and maintained. However, for layer-3 relaying, the end-to-end QoS is lost at the relay side because the latter alters and translates the original QoS flows metrics to corresponding relay-specific metrics.

Sidelink discontinuous reception (“DRX”) cycle and channel partial sensing partially address the issue of device battery consumption. A sidelink device is configured with a DRX cycle that consists of a period of monitoring control channels to determine if there is a scheduled sidelink reception, and a period of deep sleeping such that power consumption of the sidelink device is optimized. Unlike RAN DRX procedures, sidelink inter-device coordination procedures must be in place for sidelink DRX, due to the distributed nature of the sidelink interface. For example, a sidelink device my transmit a sidelink scheduling information towards another sidelink device in proximity that is currently deep sleeping, leading to the sleeping device missing the detection of the scheduling information, and accordingly, increasing the sidelink transmission latency. Thus, sidelink devices in proximity coordinate on DRX cycles that are common at least between device pairs of interest.

Regarding partial channel sensing, sidelink devices implementing continuous channel sensing need to always monitor sidelink control channels for potential scheduled transmissions, which results in significant battery power consumption due to the frequent blind decoding attempts. With partial channel sensing and sidelink DRX, the scheduling of the control channel is preconfigured during certain periodic occasion that sidelink devices expect to perform channel sensing. Thus, partial channel sensing enables sidelink devices to deep sleep over extended periods of time, even during a sidelink DRX channel wake period.

However, due to the functionality that the sidelink relays perform, power consumption is exacerbated for sidelink relays compared to non-relay sidelink UEs. That is, a sidelink relay needs to perform RAN-like procedures as well as sidelink functions for the relay device itself and its connected remote sidelink devices, leading to significant battery consumption. A sidelink relay relays traffic and performs RAN/sidelink functions on behalf of the connected remote sidelink devices. A sidelink relay may monitor and decode RAN/sidelink paging on behalf of remote devices. The higher the number of remote devices that are connected to the relay as part of a sidelink group, or zone, the more the number of paging occasions the sidelink relay monitors, detects, and decodes, which consumes battery power of the sidelink relay at a high rate. In addition, a sidelink relay may perform sidelink routing and relaying of traffic towards not-in-RAN-coverage sidelink devices. A sidelink relay device may also perform continuous and/or partial channel sensing on behalf of connected in-coverage remote sidelink devices. Such upgraded, or additional, functionality of sidelink relay devices introduces a power consumption limitation at the device end. Thus, power saving optimization procedures are desirable to enhance battery charge/energy availability at battery powered sidelink relays.

User equipment devices of a multi-device group may dynamically coordinate among each other to perform a certain function at a certain device or to relax a certain radio function from a certain coordinating device. For example, one of the group of user equipment devices can function as a relay device that communicates with a RAN or a source UE having traffic to be delivered to a destination UE, which may not be reachable by the source device via a direct sidelink link (or other short-range communication link) or within cell coverage range of the RAN. The relay UE may be referred to as a primary relay UE or as a primary UE. The other members of the group may be referred to as remote, secondary, or tethered UE devices, and may also be relay user equipment. In some embodiments disclosed herein, a secondary UE may be an intermediate UE. A secondary UE may also be a destination UE, or target UE, to which traffic from a source user equipment is directed or to which the traffic is to be delivered.

Sidelink communications are characterized by devices directly communicating among, or with, each other, where sidelink traffic and links can be controlled one-by-one by a RAN node or may be organized to operate with each other according to a configuration received from a RAN node. Sidelink communications may facilitate use cases over cellular systems including services such as reliable vehicle-to-vehicle communications, and critical factory automation. A performance aspect, quality, or characteristic, that may be important for certain use cases is an end-to-end (“E2E”) quality of service (“QoS”). ‘E2E QoS’ may refer to QoS performance from an application layer at a source UE device to an application layer at a destination device or server. Thus, E2E QOS may reflect, or be indicative of, a user's experience of utilizing one or more applications over 5G networks that may require high and reliable data transfer rates. For sidelink communications, where a source device communicates with another device, which other device is not in proximity of the source UE (e.g., a short-range wireless communication link between the source UE and the other UE cannot be established because of weak signal strength, signal interference, or noise, etc.), sidelink traffic may flow via multiple links, or ‘hops’, between multiple relay devices until the sidelink traffic reaches the intended destination device, (this scenario may be referred to as multi-hop sidelink communication). Accordingly, the sidelink E2E QoS between the source UE and destination UE may be impacted by the multiple hops of a multi-hop sidelink communication, (e.g., a communication link from the source device to a first relay UE device, a communication link from the first relay UE to a second relay UE device, and so on, to the destination UE device). However, to support, facilitate, or optimize E2E QOS targets, the source sidelink devices needs to be aware of the expected QoS over of each of the sidelink hops until the destination device so that transmission of the sidelink traffic is dynamically tuned according to performance parameter metrics indicative that impact the E2E QoS. Such optimized dynamic tuning typically does not present a channel scheduling problem for single link communication from a RAN to devices and vice versa. However, for multi-hop sidelink deployments, a source device currently sequentially collects per-hop-specific QoS reports first before initiating an E2E sidelink communication. With several multiple hops between a source UE device and a destination UE device, this can place high demand on sidelink control and data channel scheduling and transmission instants, which demand typically results in high consumption of resources of both sidelink control channels and data channels because of QoS control information and report feedback being transferred between each UE corresponding to each hop of a multi-hop sidelink communication and the source UE, respectively.

Accordingly, with embodiments disclosed herein, dynamically splitting E2E QoS reporting into partial E2E QoS reports that are adaptively compiled at a selected set of intermediate relay UE device facilitates a reduction of resources used to notify, or make aware, a source device of an overall E2E QoS channel condition, or conditions. Partial E2E QoS reports may be aggregated and reported back to the requesting source device by one or more relay UE devices. In an embodiment, multiple relay UE devices may be grouped into separate subsets, or subgroups, each with a lead relay UE, or master relay UE, that reports back a partial E2E QoS report to the source UE indicative of QoS of short-range communication links corresponding to the subset/subgroup. Thus, QoS split reporting embodiments disclosed herein facilitate a significant reduction in use of control channel overhead and delay of source sidelink devices acquiring the E2E QoS corresponding to sidelink links between the source UE and the destination UE. In an example scenario having a primary relay UE in communication with a source UE and two secondary/intermediate relay UE devices facilitating hops between the primary relay UE and a destination UE, a reduction of overhead use of about 33% using embodiments disclosed herein may be achievable because transmission of partial QoS information uses resources for only eight scheduled UE-to-UE control channel messages instead of twelve. In other words, instead of a separate request being transmitted from the source device to each of the relay UE devices via links of the multi-hop chain of relay device and then each relay device transmitting back to the source device a respective relay device's QoS report via links of the chain, the primary relay device receives a request for an E2E QoS report. The primary UE then transmits requests for partial QoS reports to individual relay devices of the chain via hops of the chain of short-range communication links, receives partial QoS reports from the individual relay UE devices via hops of the chain, aggregates information gleaned from the partial QoS reports into an E2E QoS report, and then transmits the E2E QoS report to the source device, thus eliminating the transmitting to each individual relay device a QoS report request from the source UE via links of the chain, and eliminating the transmitting of reports corresponding to the requests from each individual relay UE to the source UE via links of the chain.

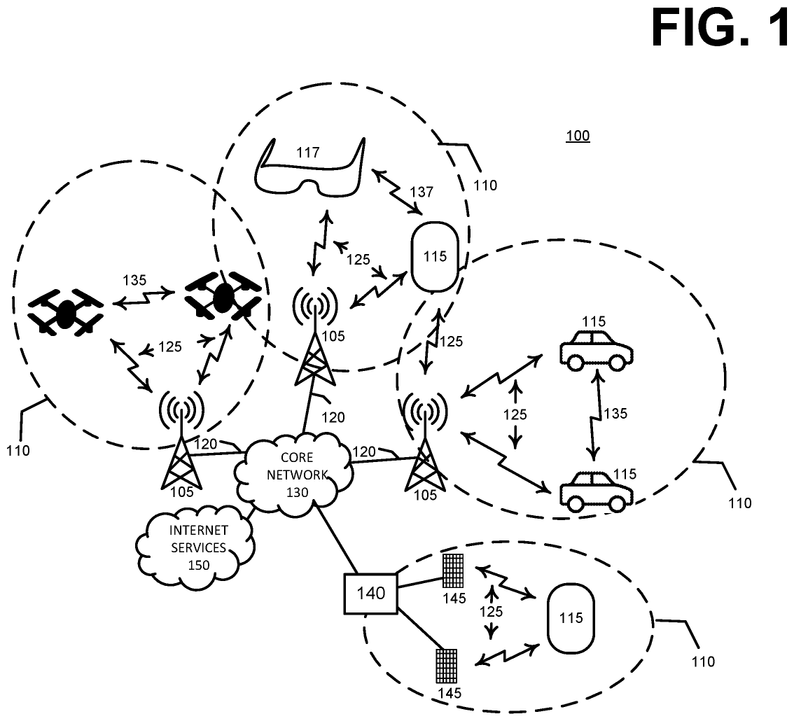

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 12.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples A UE 11S may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR) Each physical layer channel may carry acquisition signaling (e.g., synchronization signals, system information), control signaling that coordinates operation for the carrier, user data, or other signaling Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)) Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 11S. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases. D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130 User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

Multi-hop sidelink communications may facilitate a source UE device delivering traffic via sidelink links to a destination UE device that is not in direct proximity with the source UE (e.g., the source UE and the destination UE are too far apart for a single short-range communication link to be established between the source and destination UE devices without using intermediate short-range communication links, or hops). Thus, an E2E sidelink communication path may be facilitated by multiple sidelink relay devices facilitating multiple hops such that one of the intermediate relay UE devices is close enough to communicate with the destination UE device via a short-range communication link. From the perspective of the source device, determining and tuning E2E QoS targets are important to fulfilling, or satisfying, desired performance targets of an application running at the destination UE (or running at the source UE). In a non-sidelink arrangement network arrangement, (e.g., a RAN communicates directly with a destination UE via a long-range communication link such as a cellular link), tuning an E2E QOS is handled by the RAN node, which determines and tunes E2E QOS metrics and associated transmission configurations based on channel quality reports received directly from the destination UE device, (e.g., single-hop feedback directly from the destination devices to the RAN without intervening hops facilitated by intermediate relay UE devices). However, in a multi-hop sidelink deployment, a source device should be aware of the current QoS performance and metrics expected over each of the sidelink hops on the path towards the intended destination device. Thus, using current techniques, source UE devices transmit QoS report requests and receive per-hop QoS report responses from all relay devices that comprise a path from the source UE device to the destination device. This results in multiple sidelink control channel and data channel scheduling and transmission instants, which typically negatively impacts overall spectral efficiency of the sidelink path. Furthermore, using current techniques, the multiple sidelink data channel and control channel scheduling and transmission of QoS requests and corresponding reporting feedback increases E2E latency of actual sidelink traffic that is transmitted from the source UE to the destination UE after the source has received the multiple QoS reports from the multiple sidelink relay UE devices.

Embodiments disclosed herein facilitate adaptive, split E2E QoS reporting, that results in an E2E QoS report being requested by a source UE but with a significant control channel overhead use reduction compared to each intermediate relay UE receiving from a source UE, and transmitting to the source UE, a QoS report request and a corresponding QoS report, respectively. Existing E2E QoS report acquisition procedures do not support multi-hop sidelink communications, (e.g., only a single hop sidelink—remote source device to remote relay device communication—is supported). Thus, using existing report acquisition procedures, a source device requests per-hop QoS reports from each UE device on a path towards the destination device—for situations with only a single side link UE device between the source and destination this is acceptable because the single intermediate relay device obtains a QoS report for a communication link from the relay UE to the destination and reports the QoS to the source UE. However, for multi hop sidelink deployments, existing QoS reporting uses signaling overhead to transport to the source UE a separate QoS report corresponding to each link of the multi-link communication path chain.

### End-to-End Sidelink QoS Split Reporting.

Using embodiment disclosed herein, a source sidelink UE device, which may initiate an E2E sidelink connection towards a certain destination device, transmits an E2E QoS report request to a first sidelink relay device, which may be referred to as a primary UE, or a primary relay UE. (It will be appreciated that the term ‘primary’ may be used to refer to a leader UE, or serving UE, of a sidelink group of UE devices). An E2E QOS request may comprise information regarding QoS metrics to be calculated and reported such as expected packet delay budgets (“PDB”) or expected packet error rates (“PER”). (It will be appreciated that many other QOS metrics may be requested in addition to, or instead of, a PDM metric or a PER metric and that PDM and PER metrics are described for purposes of example.) Therefore, the first serving relay device (e.g., a primary UE) determines a set of intermediate sidelink relay devices that may make up part of, or all of, a sidelink communication path towards the destination device, and transmits a partial QoS report request towards those UE devices that make up the determined set of intermediate sidelink relay devices. A partial QoS report request may comprise an indication requesting that a relay UE device, which has received the partial QoS report request, report QoS metrics that correspond to a certain number of sidelink hops (e.g., hops that correspond to the relay UE devices that are part of the determined set of intermediate sidelink relay devices).

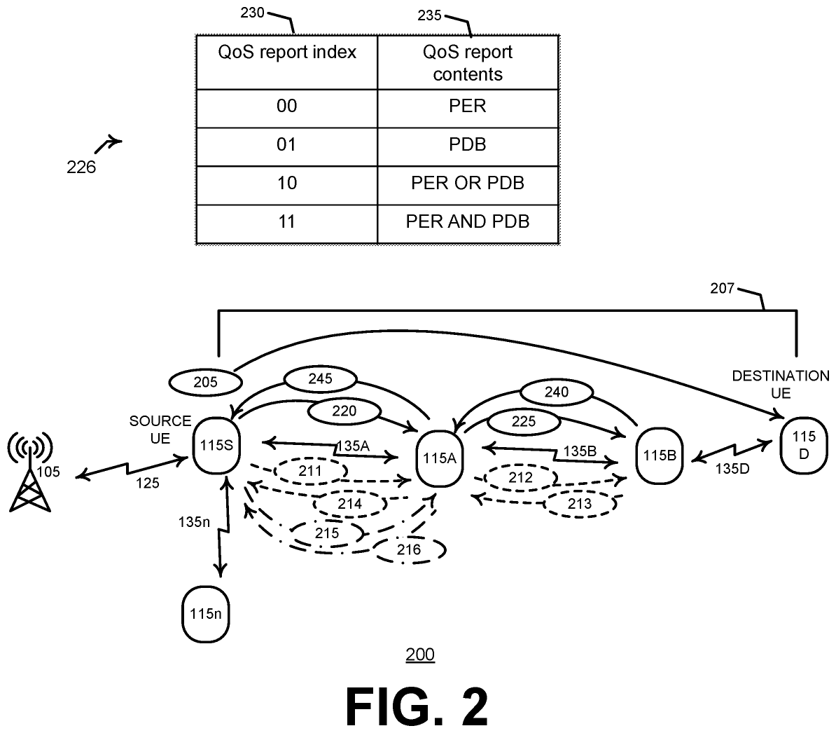

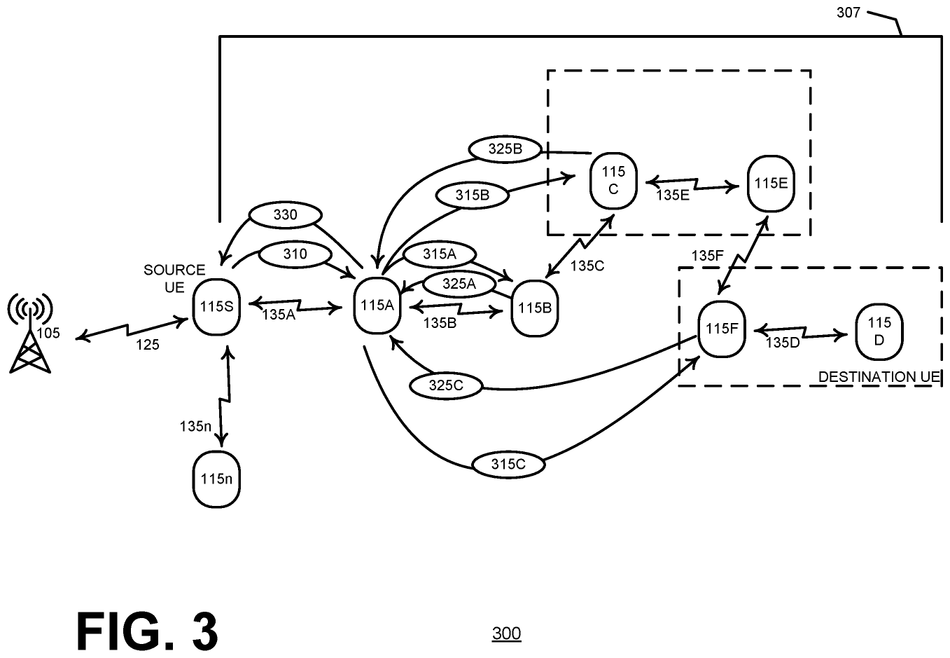

Partially aggregated QoS reporting of QOS metrics may be based on QoS metrics corresponding to the primary UE and other relay UE devices of the determined set of intermediate sidelink relay devices that make up part of, or all of, path towards the destination device. For example, an intermediate relay device can receive, from a primary UE, a partial QoS report request that requests reporting of metrics corresponding to the three next sidelink hops (in a direction towards the destination UE device) starting from the receiving intermediate relay UE. The receiving intermediate relay UE may compile a partial QoS report, where the QoS metrics per hop are dynamically aggregated to compile a single partial QoS report, which reflects an aggregated, or overall, QoS condition, or conditions, of hops corresponding to the three sidelink hops in the example. The primary relay device receives one or more partial QoS reports from leader UE devices of one or more determined groups of relay UE devices and compiles an aggregated E2E QoS report. The primary relay device then transmits the E2E QoS request response towards the original requesting remote source device that includes requested E2E QoS metrics. The remote source sidelink device becomes aware of the E2E QOS metrics that reflect an overall QoS performance of the multi-hop sidelink path towards the destination device and may accordingly adaptively tune sidelink traffic transmission configurations based on received E2E QOS metrics report. Thus, the sidelink path length over which individual QoS report request and corresponding report feedback exchanges are transported is shortened (e.g., number of hops is reduced) and thus control overhead is significantly reduced. In an example described above having a multi-hop, or multi-link, communication path comprising two relay UE devices between a primary UE and the destination UE, a reduction of approximately 33% of control channel overhead resources may be achieved using embodiments disclosed herein compared to existing procedures for a source sidelink device to acquire E2E QOS metrics. A similar reduction may be achievable for a system comprising one sidelink relay UE between a primary relay UE and a destination UE (e.g., scheduling of resources to transport 4 messages instead of 6). Adding an additional secondary, or intermediate, relay UE between a primary relay UE and the destination UE (e.g., a primary relay UE and three secondary relay UE devices) results in a nominal scheduled resource reduction of 30% (14 messages using techniques disclosed herein compared to 20 messages for existing techniques), or a nominal reduction of scheduled resources of about 26% (22 messages compared to 30 messages) when yet another intermediate sidelink relay UE is added to the multi-hop, or multi-link) communication path. The term ‘nominal’ is used because resource use may not always be an exact multiple of a number of messages due to possible variations in message content or format, which may affect the size of a QoS report. As can be seen from the numerical examples given of potential control channel resource use reduction, as more intermediate relay UE devices are added to a multi-link chain between a source UE and a destination UE, the difference between resources used according to techniques disclosed herein (e.g., in reference to FIG. 2) gets smaller compared to resources used according to existing techniques. Accordingly, additional techniques that use multiple subsets, or subgroups, of intermediate relay devices as described in reference to FIG. 3 may further reduce resource use when many intermediate relay UE devices are used, for example, to facilitate a multilink communication path over a long distance from a source UE to a destination UE.

As depicted by FIG. 2, a deployment of multi hop sidelink network system 200 is shown. Source device 115S initiates an E2E connection to transmit traffic 205 to destination device 115D, which is not in direct communication proximity (e.g., within short-range communication link range) to the source device. Traffic 205 may have been received at source UE 115S from RAN 105 or from another UE 115n. Traffic 205 may be transported from source UE 115S to destination UE 115D via two successive sidelink relay UE devices 115A and 115B over three sidelink hops/communication links 135A, 135B, and 135D. For source device 115S to determine E2E QOS metrics, and accordingly, enforce/implement a transmission configuration appropriate for the E2E QOS metrics for transmission of traffic 205, the source UE should be made aware of the per-hop QoS current performance and/or metrics (e.g., metrics indicative of conditions of links 135A, 135B, and 135D) that may comprise, for example, expected PER and PDB over each hop/link 135. Source device 115S can only unilaterally become aware QoS metrics corresponding to link 135A and cannot become aware of QoS performance metrics corresponding to links 135B or 135D without receiving reports corresponding thereto that are generated by primary relay UE device 115A and intermediate relay UE 115B. As discussed above, existing techniques only support single hop sidelink deployments, where the source device is initially only unaware about QoS performance of a single hop. For example, existing techniques might support sidelink communication from UE 115S to UE 115D via relay UE 115A if secondary UE 115B were not used as part of multi-link path 207 and if UE 115A communicates with UE 115D directly using link 135D.

In example system 200 shown in FIG. 2, source device 115A is not independently aware of QoS performance metrics corresponding to communication links 135B and 135D. Thus, using existing techniques, source device 115S would need to transmit a QoS request to each of the relay UE devices 115A and 115B, to obtain performance parameter metrics corresponding to links 135B and 135D. Using existing techniques, a QoS request 211 directed from source UE 115S to relay UE 115B would need to be transported via primary relay UE 115A as another scheduled message 212. Relay UE device 115B would then need to determine performance metrics for link 135D, generate a QoS report 213 corresponding thereto, and responsive to the QoS report request transmitted from source UE 115S via primary relay UE 115A, transmit back to source UE 115S the QoS report 213 via primary UE 115A, which would relay the report as message 214. Thus, using existing techniques for source UE 115S to obtain a QoS report that indicates performance of link 135D, control channel resources would have to be scheduled to: transmit request 211 from source UE 115S to primary relay UE 115S; relay the request as message 212 from the primary relay to secondary relay 115B; transmit a QoS report 213, responsive to the QoS request message 212, from secondary relay UE 115B to primary relay 115A; and relay the responsive report from primary relay UE 115A to the source UE 115S as message 214. Such a procedure results in the scheduling of and the using of sidelink overhead resources for four messages in addition to resources needed for two messages 215 and 216 used to transmit a QoS request from source UE 115S to primary relay 115A and to transmit a responsive QoS report from the primary relay back to the source UE, respectively, for a total of six messages needing resources according to existing techniques. Messages 211, 212, 213, and 214 are shown in a first style of broken line to indicate that they are related to transporting a report request to secondary relay UE 115B and transporting a responsive report back to source UE 115S relative to performance metrics corresponding to link 135D. Messages 215 and 216 are shown in a second style of broken line to indicate that they are related to transmitting to, and receiving from, UE 115A a QoS request and responsive QoS report, respectively, relative to performance parameter metrics corresponding to link 135B.

Thus, in the example shown in FIG. 2, using existing techniques six various control/data channel scheduling and transmission instants are needed for source UE 115S to become aware of the E2E QOS metrics of communication path 207 comprising links 135A, 135B, and 135D, and to accordingly be able to start transmitting sidelink traffic 205 to destination UE 115D. Clearly, with more intermediate hops along path 207 towards the destination device, signaling overhead and latency would be progressively increased to obtain E2E QOS metrics at the source device, thus leading to degradation of sidelink spectral efficiency.

By using embodiments disclosed herein, source UE 115S may transmit a request 220 for an E2E QoS report to primary relay UE 115A. (It will be appreciated that request message 220 may be the same message as message 211.) Primary relay UE 115A may then generate a partial QoS report request 225 and transmit the partial report request to secondary relay UE 115B. As shown in FIG. 2, a QoS split report facilitates performance metrics corresponding to link 135D being transmitted to primary relay 115A as partial QoS report message 240. Primary UE 115A then aggregates QoS metrics corresponding to link 135D as indicated in report message 240 with performance metrics corresponding to link 135B (that the primary relay UE may determine) into an aggregated QoS report and transmits the aggregated QoS report in message 245 to source UE 115S. (It will be appreciated that the aggregated QoS report may be referred to as a combined QoS report or a composite QoS report; in the example shown in FIG. 2, the QoS message transported in message 245 is also an E2E QoS report.) Instead of six messages being used for source UE 115S to obtain performance parameter metrics corresponding to a links 135B and 135D (the source UE can independently determine performance parameter metrics corresponding to link 135S), using partial QoS report requests and aggregated QoS reports as disclosed herein, only four messages 220, 225, 240, and 245 are used to make source UE 115S aware of performance parameter metrics corresponding to links 135B and 135D.

In an embodiment, source UE 115S transmits a QoS report request indication only towards primary sidelink relay node 115A, which may determine one or more subsets, or subgroups, of sidelink nodes, or relay UE devices, on path 207 towards destination device 115D. Primary relay UE 115A may then transmit a partial QoS request indication towards all devices belonging to each of the smaller subset(s)/subgroup(s).

As shown in FIG. 2, a QoS report request 225 may comprise index values 230 that correspond in configuration 226 to a set of possible QoS metrics 235 to be calculated, aggregated, and reported back to a primary UE, or to a subgroup leader UE, and ultimately to source UE 115S. A partial QoS report request 225 may comprise information elements 235 corresponding to performance parameters, such as, for example, a feedback QoS report response including PER or PDB metrics or combinations thereof, or a number of hops over which the primary relay UE, or subgroup leader UE, should determine QoS metrics and include the metrics in a partial QoS report response 240 as shown in FIG. 2.

Accordingly, each selected intermediate device (selected by a primary UE) of a subgroup (only intermediate device 115B is shown in FIGS. 2A and 2B, but other intermediate devices could also be part of a group or subgroup), upon receiving a partial QoS report request from a primary relay UE, may determine a number of hops they must cover in their QoS report response feedback (e.g., a given intermediate UE of a subgroup may aggregate reports received from other intermediate UE devices of the subgroup that are closer to the destination UE than the given intermediate UE). It will be appreciated that there may not be a subdivision into subgroups (e.g., there is only one group of relay devices as depicted by UEs 115A and 115B in FIG. 2). An intermediate UE may determine per-hop QoS metrics and may partially aggregate the determined partial QoS metrics into a partial QoS report 240 as shown below in Table 1.

TABLE 1
Partial PER (covering a signaled number of hops N, relative to a
determining or a primary UE) =
PER_hop_1 x PER_hop_2 x ... x PER_hop_N
Partial PDB (covering a signaled number of hops N, relative to a
determining or a primary UE) =
PDB_hop_1 + PDB_hop_2 + ... + PDB_hop_N

Selected intermediate sidelink devices may report back a partial QoS report response 240 that may comprise calculated partial PER and PDB metrics and that may reflect partially aggregated QoS metrics over the N number of hops ahead of the device. For example, in FIG. 2, N=2 and primary relay 115A aggregates QoS metrics received in message 240 relative to link 135D and metrics relative to link 135B determined by UE 115B. In a multi-group scenario, a primary relay device may synthesize/aggregate multiple partial QoS report responses 240 in a similar way as the partial QoS metrics themselves are aggregated to form a report 240. Accordingly, a single E2E QoS report response 245 is compiled and transmitted back by primary UE 115A to the requesting source UE device 115S, including E2E QOS metrics that reflect the actual QoS performance of all hops on the path 207 towards the destination device. Referring to the example of FIG. 2, a total of four instants of scheduling and control/data transmission are used to apprise requesting source device 115S of the E2E QOS metrics. Compared to existing procedures, where a total of six instants of scheduling and transmissions are needed for E2E QoS acquisition (e.g., messaging shown in broken lines in FIG. 2), as discussed above, using embodiments disclosed herein may result in a 33% reduction of the exhibited control and data channel signaling overhead (e.g., four messages compared to six).

As a number of intermediate user equipment of a sidelink communication path increases, dividing the intermediate user equipment into subgroups of the group of relay user equipment that make up the path may further reduce overhead resource consumption. As depicted in FIG. 3, source UE 115S transmits an E2E QoS request 310 to primary UE 115A Primary UE 115A determines subgroups of a group of UE devices 115A-115F that make up sidelink path 307. Subgroup 312 comprises UE relay devices 115C and 115E and subgroup 314 comprises relay UE 115 and destination UE 115D (it will be appreciated that UE 115D may not be a relay UE but relay UE 115F determines performance parameter metrics corresponding to link 135D). Primary UE transmits a first partial QoS report request 315A to secondary relay UE 115B Primary UE transmits (via UE 115B) a second partial QoS report request 315B to secondary relay UE 115C, which is a leader UE of subgroup 312. Primary UE transmits (via UE devices 115B, 115C, and 115E) a third partial QoS report request 315C to secondary relay UE 115F, which is leader of subgroup 314 (it will be appreciated that subgroup 314 may comprise additional relay user equipment between UE 115F and UE 115D). UE devices 115B, 115C, and 115F transmit (via respective links of path 307) to primary UE 115A partial/combined QoS reports 325A. 325B, and 325C, respectively. It will be appreciated that although partial/combined QoS reports 325A, 325B, and 325C are shown in FIG. 3 as being transmitted to primary UE 115A, the partial/combined QoS reports are actually transmitted via preceding links between a relay UE transmitting a partial QoS report and the primary UE (e.g., partial QoS report 325C is transmitted via link 135F to UE 115E, which transmits report 325C to via link 135E UE 115C, which transmit report 325C via link 135C to UE 115B, which transmits report 325C via link 135 B to primary relay 115A).

Primary UE 115A aggregates performance parameter metrics indicated in reports 325A, 325B, and 325C into end-to-end Quality-of-Service report 330 to source UE 115S for use in transmitting traffic to destination UE 115D. Subgrouping may be useful to facilitate primary UE 115A determining a weakness/low quality of a particular link. For example, if based on historical data UE 115A has access to information that indicates links 135C and 135F are problematic links, UE 115 may purposefully select UE 115C and UE 115E as part of subgroup 312 so that UE 115B may be able to separately determine QoS corresponding to links 135C and 135F instead of compiling a report that mixes, and thus perhaps ‘anonymizes’, QoS metrics corresponding to link 135C with metrics corresponding to links 135E, 135F, and 135D.

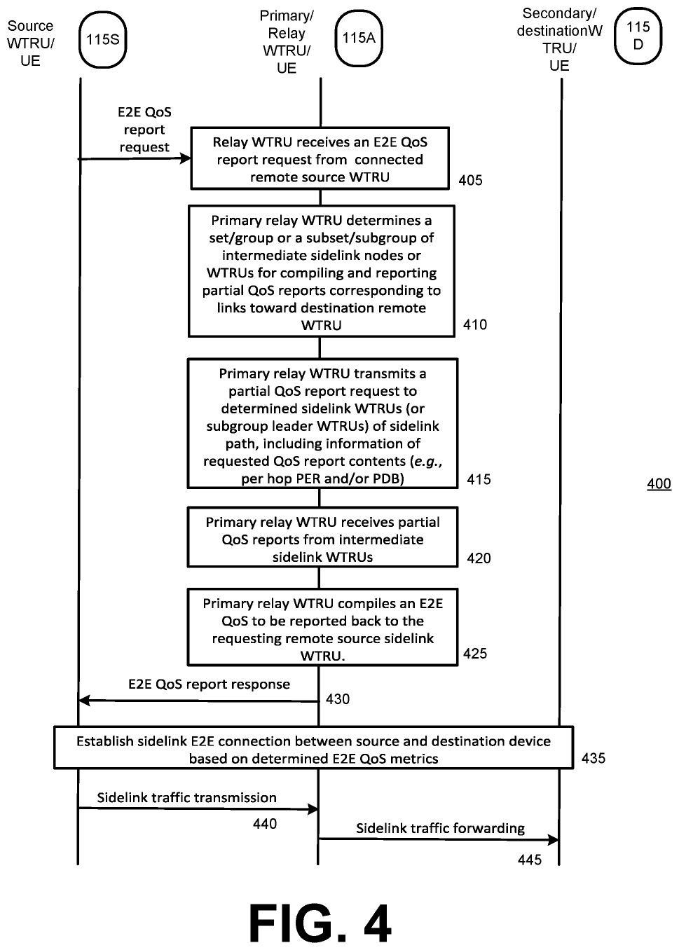

Turning now to FIG. 4, the figure illustrates a timing diagram of an example method 400 to facilitate split reporting of intermediate sidelink path hop metrics. At act 405, primary relay UE 115A receives an E2E QoS report request from connected source UE/WTRU 115S. Source UE 115S is referred to as ‘connected’ insofar as source UE 115S is communicatively connected to a RAN, or another UE, and has received therefrom traffic to be delivered to destination remote WTRU/UE 115D, which may not be communicatively connected to the RAN or to another UE that has traffic to be delivered to the destination UE.

At act 410, primary relay UE/WTRU may determine a set/group or a subset/subgroup of intermediate sidelink nodes (e.g., UE/WTRUs) for compiling and reporting partial QoS reports corresponding to communication links that make up a communication path between the primary UE 115A and the destination UE 115D. At act 415, primary relay UE/WTRU 115A transmits a partial QoS report request to each determined sidelink UE/WTRUs (e.g., intermediate relay UE devices, which may be leader devices of a subgroup determined at act 410) along a sidelink path to destination sidelink UE/WTRU. A partial QoS report request may comprise a request for QoS performance parameter metric information that should be included in a partial QoS report corresponding to links of the communication path (e.g., a partial QoS report may be requested to comprise per hop PER and/or PDB metrics or aggregated/blended metrics). A partial QoS request may comprise an indication index, such as an index 230 shown in FIG. 2, that an intermediate UE may use to look up a parameter, or parameters, for which metric(s) are being requested in a partial QoS report request. The parameter, or parameters, may be looked up in a configured table, such as table 226 shown in FIG. 2, based on the QoS report index indicated in the partial QoS report request.

Continuing with description of FIG. 4, at act 420, primary relay UE/WTRU 115A receives one or more partial QoS reports from intermediate sidelink WTRUs that the intermediate relay UE devices determined and transmitted responsive to receiving partial QoS report requests that were transmitted at act 415. At act 425, primary relay UE/WTRU 115A compiles an aggregated E2E QoS, responsive to the E2E QoS report request received at act 405, and transmits the aggregate E2E QoS report to requesting remote source sidelink WTRU 115S.

At act 435, source UE 115S, primary relay UE 115A, destination UE 115D, and intermediate UE devices that make up a sidelink communication path between the primary UE and the destination UE, establish a sidelink connection between the source UE and the destination UE via communication links that communicatively connect the relay devices to each other, to the source UE, and to the destination UE. At act 440, source UE 115S transmits traffic, which may be directed to destination UE 115D, to primary UE 115 according to tuning at an application layer of the source UE based on the E2E QoS report transmitted at act 430. At act 445, primary relay UE 115A receives the traffic transmitted at act 440 according to the E2E QoS report and relays/forwards the traffic to destination UE 115D, via intermediate relay UE devices if any.

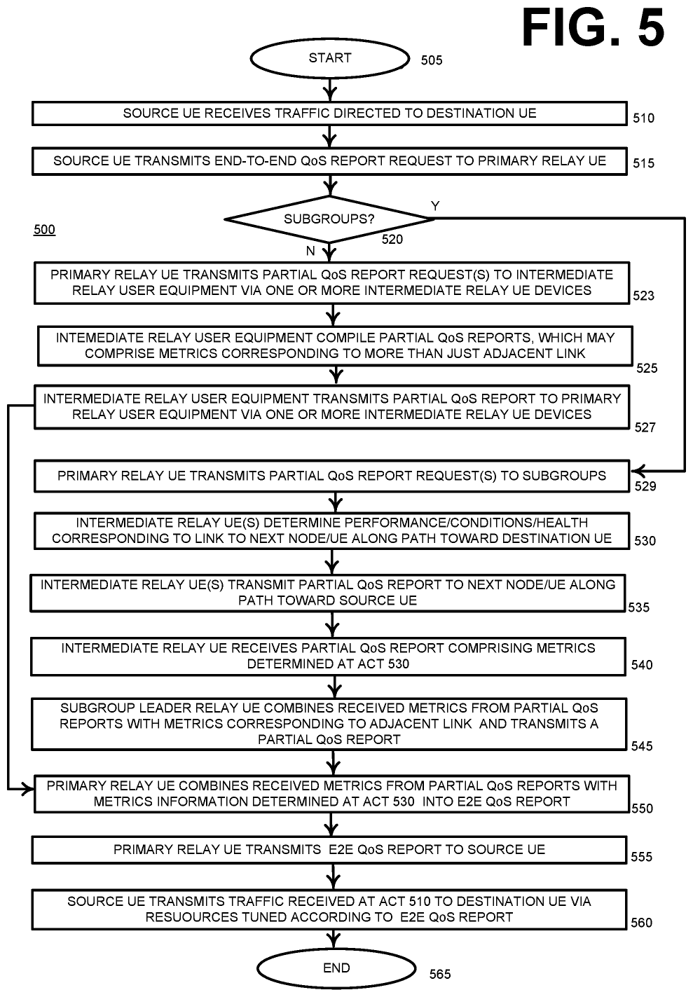

Turning now to FIG. 5, the figure illustrates a flow diagram of an example method embodiment 500 to facilitate split reporting of intermediate sidelink hop metrics. Method 500 begins at act 505. At act 510, a source user equipment receives traffic directed to a destination user equipment. The source user equipment may receive the traffic from a radio access network node, a server, a user equipment, or other type of device. At act 515, the source user equipment transmits an end-to-end quality-of-service (“E2E QoS”) report request to a primary relay user equipment. The E2E QoS may request reporting of metrics corresponding to parameters, which the source user equipment may select based on a type of service needed. For example, of a service requires only ‘best effort’, the source may only request latency-related metrics and not request metrics corresponding to other parameters such as PER or PDB whereas the source UE may request PER or PDB for example, if a higher reliability service than best effort is needed for the traffic to be delivered to the destination UE. The primary relay user equipment may be part of a sidelink group of user equipment, for example a group of user equipment that communicate with each other via sidelink communication links, or other short range communication links, that facilitate transport of traffic between the source user equipment and the destination user equipment, which may be outside of a communication range of the source user equipment, the radio access network node, or other device that may have traffic to be delivered to the destination user equipment. The primary user equipment may determine members of the sidelink group that comprise a path, or chain, to the destination user equipment using sidelink routing. User equipment of the sidelink group, other than the primary relay user equipment, may be referred to as secondary relay user equipment.

At act 520, the primary user equipment determines whether the side link group of relay user equipment should comprise subgroups of the secondary relay user equipment. If the determination made at act 520 is no, that the group of side link user equipment should not be divided, or subdivided, into subgroups, method 500 advances to act 525. The primary user equipment may determine to subdivide the sidelink group into subgroups for various reasons, including, if, for example, one or more links between members of the side link group have been determined in the past to exhibit, or are currently exhibiting, poor performance.

At act 523, the primary relay user equipment transmits a partial quality of service report request, or requests, to one or more intermediate/secondary relay user equipment devices. The partial QoS report request may request one or more performance metrics corresponding to one or more performance parameters, such as for example, parameters described in reference to configuration 226 shown in FIG. 2. Continuing with description of FIG. 5, at act 525, one or more user equipment may determine metrics corresponding to performance condition parameters or health condition parameters corresponding to a communication link to a next node (e.g., a next user equipment) along the sidelink path toward the destination user equipment. At act 527, an intermediate relay user equipment may transmit a partial QoS report to another intermediate user equipment, or to a primary relay user equipment, via links of the sidelink path toward the source user equipment. The partial QoS report may comprise performance parameter metrics indicative of performance conditions or health conditions determined at act 525. Performance condition metrics, or link health conditions metrics, corresponding to the link to the next node along the path towards the destination user equipment may comprise only metrics determined by an intermediate relay user equipment.

In an embodiment, performance condition metrics, or health condition metrics, may comprise a combination of metrics. The combination of metrics may comprise one or more combined metrics corresponding to parameters requested in the E2E QoS report request transmitted at act 515, that reflect not only performance conditions/health conditions of a link to a next node toward the destination user equipment but also performance/conditions health conditions corresponding to other links along the sidelink path toward the destination user equipment. For example, a first secondary relay user equipment, (e.g., intermediate relay user equipment) may receive a partial QoS report request from a primary relay user equipment. The first secondary relay user equipment may determine performance parameter metrics corresponding to a link connecting the first secondary relay user equipment to a second secondary relay user equipment. The second secondary relay user equipment may determine performance parameter metrics corresponding to one link, or more than one link (e.g., via a partial QoS reports received from a third secondary user equipment), between the second secondary relay user equipment and the destination user equipment. The second secondary relay user equipment may transmit a partial quality of service report to the first secondary user equipment, which may combine metrics indicated by the partial quality of service report received from the second secondary user equipment with metrics that the first secondary relay user equipment determined as corresponding to the link between the first secondary relay user equipment and the second secondary relay user equipment. Thus, a partial quality of service report that the first secondary relay user equipment may transmit, in a direction along the communication sitelink path toward the source user equipment, to another secondary relay user equipment, or to a primary relay user equipment, may reflect not only performance parameter metrics corresponding to the link between the first secondary relay user equipment and the second secondary relay user equipment, but also corresponding to other links along the side link communication path toward the destination user equipment. Accordingly, a partial quality of service report may reflect, or be indicative of, conditions of more than just one link of a side link communication path toward a destination user equipment.

At act 550, a primary relay user equipment combines received metrics extracted from partial quality of service reports with metrics that the primary relay user equipment may have determined as corresponding to a link adjacent to the primary relay user equipment into an end to end quality of service report. At act 555, the primary relay user equipment transmits the end to end quality of service report to the source user equipment. At act 560, the source user equipment transmits traffic received at act 510 to the destination user equipment via resources that have been optimized according to the E2E QoS report. The optimizing of resources may comprise scheduling timing or frequency resources along the side link communication path between the source user equipment and the destination user equipment. Method 500 advances to act 565 and ends.

Returning to description of act 520, if a determination is made at act 520 that the group of side link user equipment should be subdivided into one or more subgroups, method 500 advances to act 529. At act 529 a primary relay transmits one or more partial quality of service report requests to one or more subgroups that may have been determined at act 520. At act 530, an intermediate relay user equipment of a subgroup made determined performance parameter metrics corresponding to a link to a next node, or next user equipment, along the communication path toward the destination user equipment. At act 535, an intermediate relay user equipment device may transmit a partial quality of service report to a next node/user equipment along the communication path toward the source user equipment. At act 540, an intermediate relay user equipment receives a partial quality of service report, from another intermediate user equipment (or from the destination user equipment if the intermediate user equipment is a last intermediate relay user equipment on the path toward the destination user equipment), which partial Qos report may comprise metrics determined at act 530. A subgroup leader relay user equipment, which subgroup leader may be a member of a subgroup that is closest to, or that does not communicate toward the source device via any other members of the subgroup, may receive a partial QoS report from one or more members of the subgroup. The partial quality of service report, or reports, received at act 540 may comprise performance metrics determined at act 530. At act 545, the subgroup leader may combine metrics from partial quality of service reports received at act 540. The combined metrics may also be combined with metrics that the subgroup leader itself may have determined as corresponding to a link adjacent to the subgroup leader that the subgroup leader may use to communicate with the destination user equipment. Method 500 advances to act 550 and operates as described above until method 500 ends at 565.

Combining of metrics by a subgroup leader at act 545, or by a primary relay user equipment at act 550, may be performed by applying a function according to a type of performance metric being combined. For example, as shown in Table 1, if a performance parameter for which metrics are being combined is a PER, per-hop, or per-link, PER metrics may be multiplied, or if a performance parameter for which performance metrics are being combined is a PDB, per-hop, or per-link, PDB metrics may be added, or summed. Examples of other functions include: filter, worst, average, or other mathematical function.

When a subgroup leader combines metrics for a given parameter and transmits the combined metrics in a partial QoS reports as a partial metric, as shown in Table 1 for example, the partial metric may be indicative of performance corresponding to links of the subgroup from the subgroup leader toward the destination UE. Thus, by combining, or aggregating, metrics before sending a partial QoS report, an overall ‘picture’ of the performance corresponding to links of the subgroup may be gleaned by the primary relay user equipment, and ultimately by the source user equipment after the source user equipment receives an E2E QoS report that is based on the combined metric(s) corresponding to the subgroup.

Moreover, by aggregating, blending, or combining, metrics for a first particular subgroup, individual partial QoS reports corresponding to individual relay UE members of the first particular subgroup are not each transmitted via other intermediate user equipment, which may be part of a second particular subgroup, between the first particular subgroup and the primary user equipment, thus reducing overhead that might otherwise be used to deliver the individual partial QoS reports to the primary relay user equipment via communication links corresponding to the second particular subgroup. Instead of each partial QoS report being transmitted from an intermediate relay user equipment that generated the partial QoS report to the primary relay user equipment (e.g., as described in reference to messages depicted by broken lines in FIG. 2), transmitting a partial QoS report corresponding to a subgroup reduces the number of messages that are used to indicate to a source user equipment a current state of links of a sidelink communication path to the destination user equipment. Using subgroups and transmitting partial QoS reports corresponding thereto may be especially beneficial when a sidelink communication path comprises multiple intermediate relay user equipment (e.g., path 307 as shown in FIG. 3 comprises four intermediate UE devices) as compared to a sidelink communication that comprises fewer relay user equipment, such as path 207 shown in FIG. 2 that only comprises one intermediate relay user equipment 115B.

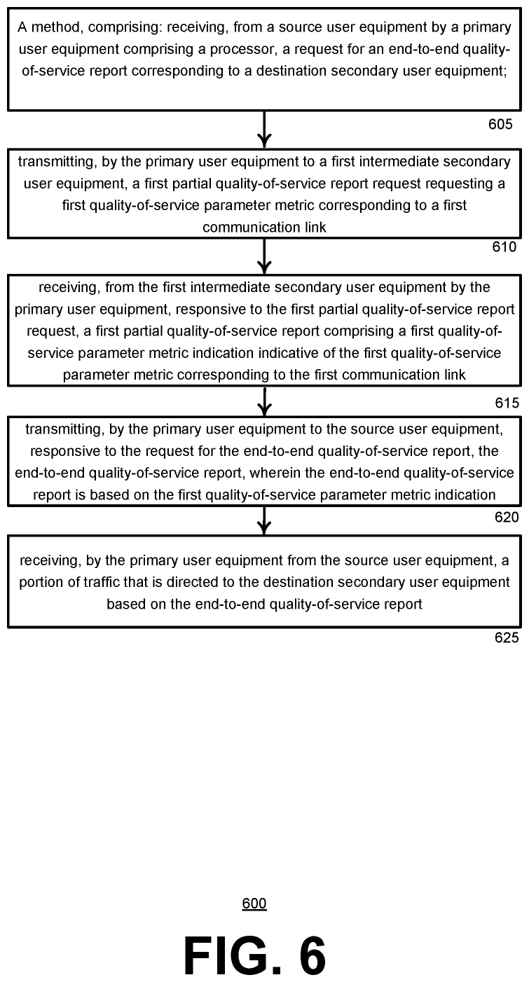

Turning now to FIG. 6, the figure illustrates an example embodiment method 600 comprising at block 605 receiving, from a source user equipment by a primary user equipment comprising a processor, a request for an end-to-end quality-of-service report corresponding to a destination secondary user equipment; at block 610 transmitting, by the primary user equipment to a first intermediate secondary user equipment, a first partial quality-of-service report request requesting a first quality-of-service parameter metric corresponding to a first communication link; at block 615 receiving, from the first intermediate secondary user equipment by the primary user equipment, responsive to the first partial quality-of-service report request, a first partial quality-of-service report comprising a first quality-of-service parameter metric indication indicative of the first quality-of-service parameter metric corresponding to the first communication link; at block 620 transmitting, by the primary user equipment to the source user equipment, responsive to the request for the end-to-end quality-of-service report, the end-to-end quality-of-service report, wherein the end-to-end quality-of-service report is based on the first quality-of-service parameter metric indication; and at block 625 receiving, by the primary user equipment from the source user equipment, a portion of traffic that is directed to the destination secondary user equipment based on the end-to-end quality-of-service report.

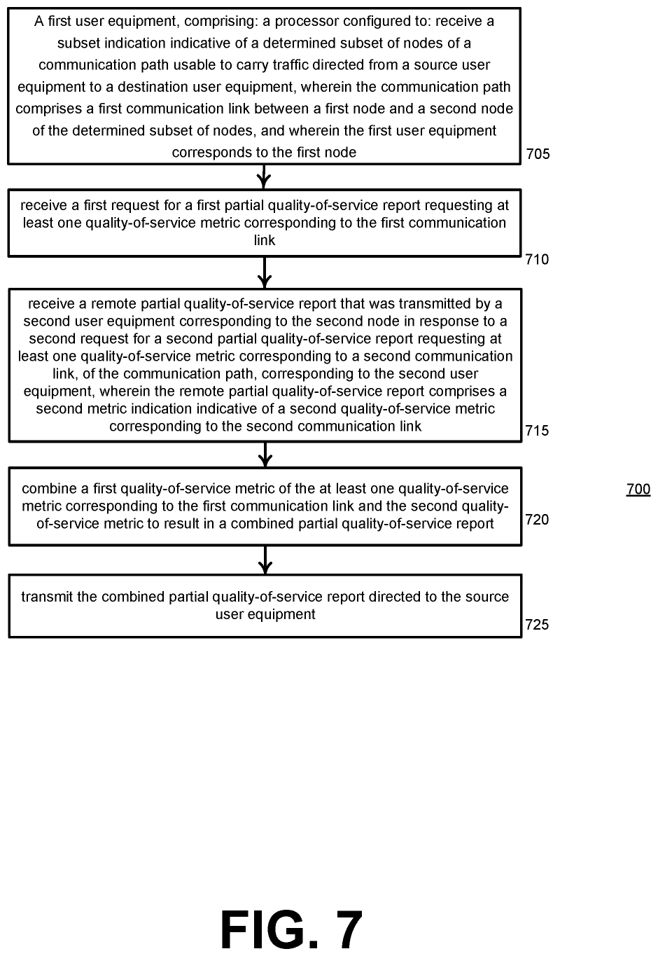

Turning now to FIG. 7, the figure illustrates an example first user equipment 700, comprising at block 705 a processor configured to: receive a subset indication indicative of a determined subset of nodes of a communication path usable to carry traffic directed from a source user equipment to a destination user equipment, wherein the communication path comprises a first communication link between a first node and a second node of the determined subset of nodes, and wherein the first user equipment corresponds to the first node; at block 710 receive a first request for a first partial quality-of-service report requesting at least one quality-of-service metric corresponding to the first communication link; at block 715 receive a remote partial quality-of-service report that was transmitted by a second user equipment corresponding to the second node in response to a second request for a second partial quality-of-service report requesting at least one quality-of-service metric corresponding to a second communication link, of the communication path, corresponding to the second user equipment, wherein the remote partial quality-of-service report comprises a second metric indication indicative of a second quality-of-service metric corresponding to the second communication link; at block 720 combine a first quality-of-service metric of the at least one quality-of-service metric corresponding to the first communication link and the second quality-of-service metric to result in a combined partial quality-of-service report; and at block 725 transmit the combined partial quality-of-service report directed to the source user equipment.

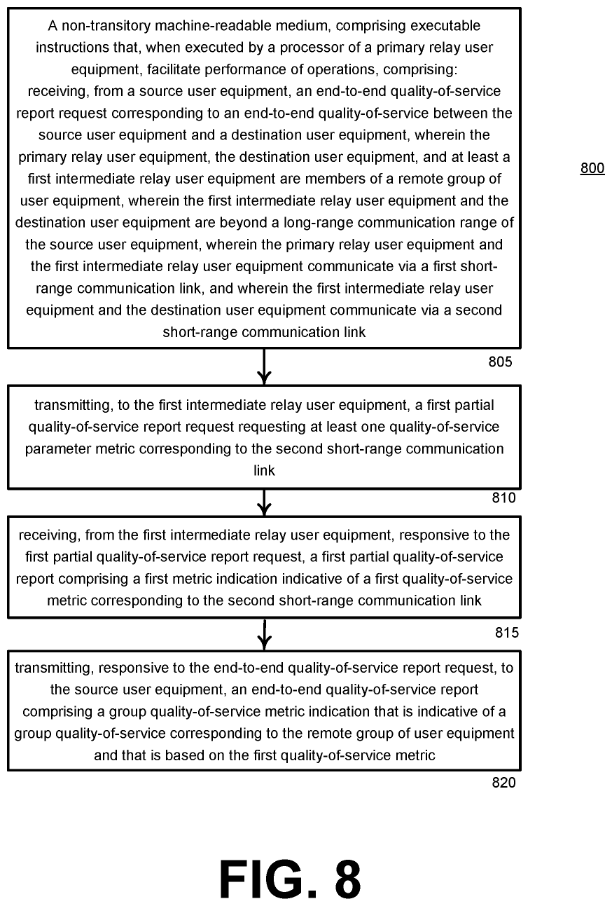

Turning now to FIG. 8, the figure illustrates a non-transitory machine-readable medium 800 comprising at block 805 executable instructions that, when executed by a processor of a primary relay user equipment, facilitate performance of operations, comprising: receiving, from a source user equipment, an end-to-end quality-of-service report request corresponding to an end-to-end quality-of-service between the source user equipment and a destination user equipment, wherein the primary relay user equipment, the destination user equipment, and at least a first intermediate relay user equipment are members of a remote group of user equipment, wherein the first intermediate relay user equipment and the destination user equipment are beyond a long-range communication range of the source user equipment, wherein the primary relay user equipment and the first intermediate relay user equipment communicate via a first short-range communication link, and wherein the first intermediate relay user equipment and the destination user equipment communicate via a second short-range communication link; at block 810 transmitting, to the first intermediate relay user equipment, a first partial quality-of-service report request requesting at least one quality-of-service parameter metric corresponding to the second short-range communication link; at block 815 receiving, from the first intermediate relay user equipment, responsive to the first partial quality-of-service report request, a first partial quality-of-service report comprising a first metric indication indicative of a first quality-of-service metric corresponding to the second short-range communication link; and at block 820 transmitting, responsive to the end-to-end quality-of-service report request, to the source user equipment, an end-to-end quality-of-service report comprising a group quality-of-service metric indication that is indicative of a group quality-of-service corresponding to the remote group of user equipment and that is based on the first quality-of-service metric.

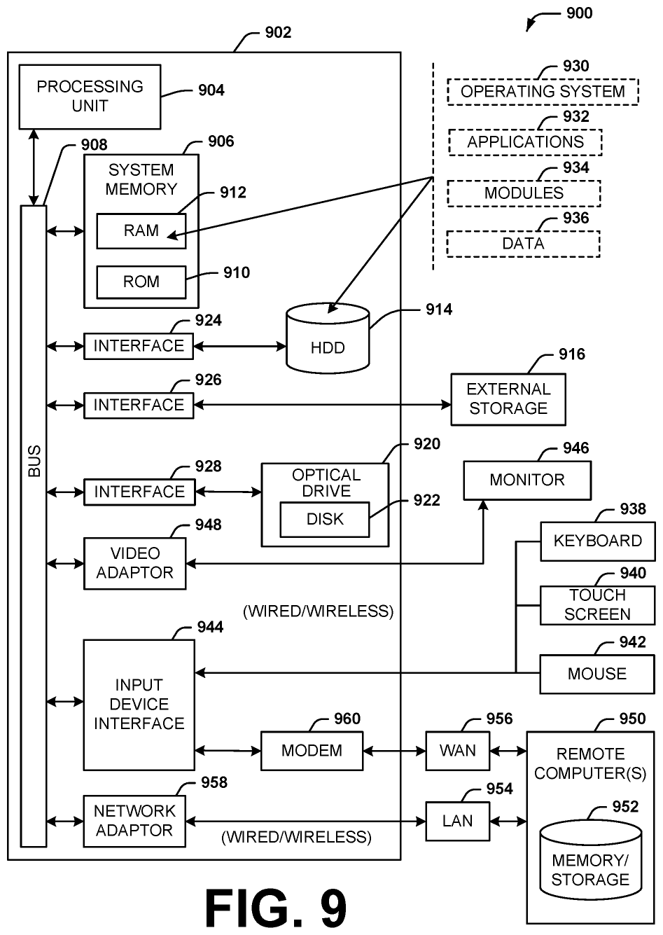

In order to provide additional context for various embodiments described herein, FIG. 9 and the following discussion are intended to provide a brief, general description of a suitable computing environment 900 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors and may include a cache memory. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

Computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can comprise a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1194 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

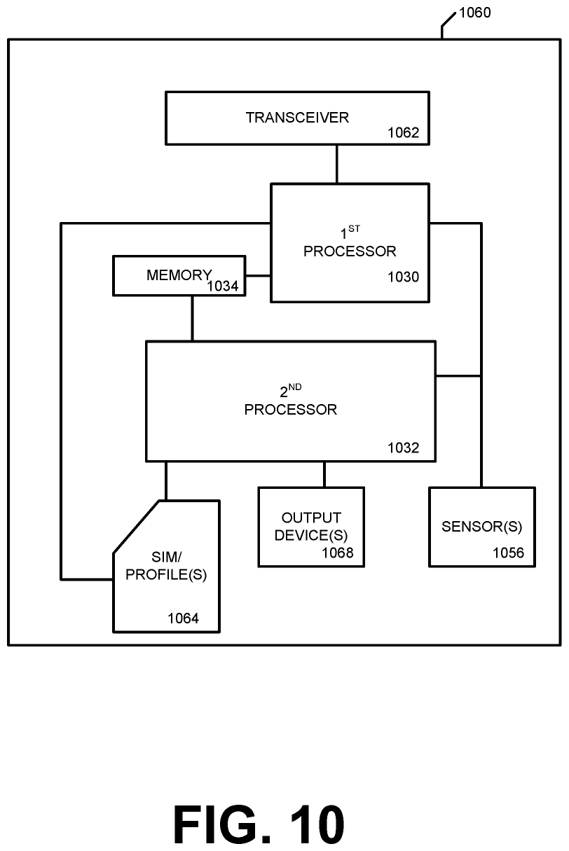

Turning to FIG. 10, the figure illustrates a block diagram of an example UE 1060. UE 1060 may comprise a smart phone, a wireless tablet, a laptop computer with wireless capability, a wearable device, a machine device that may facilitate vehicle telematics, a tracking device, remote sensing devices, and the like. UE 1060 comprises a first processor 1030, a second processor 1032, and a shared memory 1034. UE 1060 includes radio front end circuitry 1062, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 1062 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 10, UE 1060 may also include a SIM 1064, or a SIM profile, which may comprise information stored in a memory (memory 34 or a separate memory portion), for facilitating wireless communication with RAN 105 or core network 130 shown in FIG. 1. FIG. 10 shows SIM 1064 as a single component in the shape of a conventional SIM card, but it will be appreciated that SIM 1064 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1064 and another device, which may be a component of RAN 105 or core network 130 shown in FIG. 1). A SIM profile 1064 may also comprise identifying information that is unique to the SIM, or SIM profile, such as, for example, an International Mobile Subscriber Identity (“IMSI”) or information that may make up an IMSI.

SIM 1064 is shown coupled to both the first processor portion 1030 and the second processor portion 1032. Such an implementation may provide an advantage that first processor portion 1030 may not need to request or receive information or data from SIM 1064 that second processor 1032 may request, thus eliminating the use of the first processor acting as a ‘go-between’ when the second processor uses information from the SIM in performing its functions and in executing applications. First processor 1030, which may be a modem processor or a baseband processor, is shown smaller than processor 1032, which may be a more sophisticated application processor, to visually indicate the relative levels of sophistication (i.e., processing capability and performance) and corresponding relative levels of operating power consumption levels between the two processor portions. Keeping the second processor portion 1032 asleep/inactive/in a low power state when UE 1060 does not need it for executing applications and processing data related to an application provides an advantage of reducing power consumption when the UE only needs to use the first processor portion 1030 while in listening mode for monitoring routine configured bearer management and mobility management/maintenance procedures, or for monitoring search spaces that the UE has been configured to monitor while the second processor portion remains inactive/asleep.

UE 1060 may also include sensors 1066, such as, for example, temperature sensors, accelerometers, gyroscopes, barometers, moisture sensors, and the like that may provide signals to the first processor 1030 or second processor 1032. Output devices 1068 may comprise, for example, one or more visual displays (e.g., computer monitors, VR appliances, and the like), acoustic transducers, such as speakers or microphones, vibration components, and the like. Output devices 1068 may comprise software that interfaces with output devices, for example, visual displays, speakers, microphones, touch sensation devices, smell or taste devices, and the like, that are external to UE 1060.

The following glossary of terms given in Table 2 may apply to one or more descriptions of embodiments disclosed herein.

TABLE 2

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| PER | Packet error rate |
| PDB | Packet delay budget |
| URLLC | Ultra reliable and low latency communication |
| CBR | Channel busy ratio |
| SCI | Sidelink control information |
| E2E | End-To-End |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, from a source user equipment by a primary user equipment comprising a processor, a request for an end-to-end quality-of-service report corresponding to a destination secondary user equipment;
transmitting, by the primary user equipment to a first intermediate secondary user equipment, a first partial quality-of-service report request requesting a first quality-of-service parameter metric corresponding to a first communication link;
receiving, from the first intermediate secondary user equipment by the primary user equipment, responsive to the first partial quality-of-service report request, a first partial quality-of-service report comprising a first quality-of-service parameter metric indication indicative of the first quality-of-service parameter metric corresponding to the first communication link; and
transmitting, by the primary user equipment to the source user equipment, responsive to the request for the end-to-end quality-of-service report, the end-to-end quality-of-service report, wherein the end-to-end quality-of-service report is based on the first quality-of-service parameter metric indication.

2. The method of claim 1, wherein the primary user equipment, the first intermediate secondary user equipment, and the destination secondary user equipment are members of a sidelink group of user equipment.

3. The method of claim 1, wherein the first quality-of-service parameter metric comprises one of: a Packet Error Rate or a Packet Delay Budget.

4. The method of claim 1, further comprising:
receiving, by the primary user equipment from the source user equipment, a portion of traffic that is directed to the destination secondary user equipment based on the end-to-end quality-of-service report.

5. The method of claim 1, wherein the request for the first partial quality-of-service report comprises a parameter index indicative of a combination of one or more parameter metrics of a configured set of parameter metrics.

6. The method of claim 1, further comprising:
determining, by the primary user equipment, an intermediate user equipment set of secondary user equipment to be used to relay at least a portion of traffic from the source user equipment to the destination secondary user equipment.

7. The method of claim 6, wherein the request for the first partial quality-of-service report requests a combined parameter metric report corresponding to the first communication link and one or more communication links corresponding to one or more intermediate user equipment of the intermediate user equipment set.

8. The method of claim 7, wherein the request is a first request, and further comprising:
transmitting, by the primary user equipment directed to a second intermediate secondary user equipment, a second request for a second partial quality-of-service report requesting at least one quality-of-service parameter metric corresponding to a second communication link,
wherein the first partial quality-of-service report is based on the second partial quality-of-service report comprising a second parameter metric indication indicative of a second quality-of-service parameter metric corresponding to the second communication link.

9. The method of claim 6, further comprising:
determining, by the primary user equipment, a second intermediate secondary user equipment, as a member of the intermediate user equipment set, to be used to relay at least the portion of traffic from the source user equipment to the destination secondary user equipment via a second communication link.

10. The method of claim 9, wherein the request is a first request, and further comprising:
transmitting, by the primary user equipment directed to the second intermediate secondary user equipment, a second request for a second partial quality-of-service report requesting a second quality-of-service parameter metric corresponding to a second communication link; and
receiving, by the primary user equipment, responsive to the second request for the second partial quality-of-service report, the second partial quality-of-service report comprising a second quality-of-service parameter metric indication indicative of the second quality-of-service parameter metric,
wherein the end-to-end quality-of-service report comprises a composite metric indication that is a function of at least one of the first quality-of-service parameter metric or the second quality-of-service parameter metric.

11. The method of claim 10, further comprising:
receiving, by the primary user equipment from the source user equipment, at least a portion of traffic that is directed to the destination secondary user equipment based on the composite metric indication.

12. A first user equipment, comprising:
a processor configured to:
receive a subset indication indicative of a determined subset of nodes of a communication path usable to carry traffic directed from a source user equipment to a destination user equipment, wherein the communication path comprises a first communication link between a first node and a second node of the determined subset of nodes, and wherein the first user equipment corresponds to the first node;
receive a first request for a first partial quality-of-service report requesting at least one quality-of-service metric corresponding to the first communication link;
receive a remote partial quality-of-service report that was transmitted by a second user equipment corresponding to the second node in response to a second request for a second partial quality-of-service report requesting at least one quality-of-service metric corresponding to a second communication link, of the communication path, corresponding to the second user equipment, wherein the remote partial quality-of-service report comprises a second metric indication indicative of a second quality-of-service metric corresponding to the second communication link;
combine a first quality-of-service metric of the at least one quality-of-service metric corresponding to the first communication link and the second quality-of-service metric to result in a combined partial quality-of-service report; and
transmit the combined partial quality-of-service report directed to the source user equipment.

13. The first user equipment of claim 12, wherein the first request for the first partial quality-of-service report comprises a request for the combined partial quality-of-service report corresponding to the determined subset of nodes, and wherein the combined partial quality-of-service report is transmitted, by the first user equipment, to the primary user equipment.

14. The first user equipment of claim 13, wherein the determined subset of nodes comprises the first user equipment, the second user equipment, and the primary user equipment; and wherein the first user equipment, the second user equipment, and the primary user equipment are included in a sidelink group of user equipment.

15. The first user equipment of claim 13, wherein the processor is further configured to transmit, to the source user equipment, an end-to-end quality-of-service report comprising an end-to-end quality-of-service indication indicative of an end-to-end quality-of-service of an end-to-end communication path between the source user equipment and the destination user equipment, and wherein the end-to-end quality-of-service report comprises the combined partial quality-of-service report.

16. The first user equipment of claim 12, wherein the combining of the first quality-of-service metric and the second quality-of-service metric comprises applying a defined function to the first quality-of-service metric and second quality-of-service metric to result in the combined partial quality-of-service report.

17. A non-transitory machine-readable medium, comprising executable instructions that, when executed by a processor of a primary relay user equipment, facilitate performance of operations, comprising:
receiving, from a source user equipment, an end-to-end quality-of-service report request corresponding to an end-to-end quality-of-service between the source user equipment and a destination user equipment, wherein the primary relay user equipment, the destination user equipment, and at least a first intermediate relay user equipment are members of a remote group of user equipment, wherein the first intermediate relay user equipment and the destination user equipment are beyond a long-range communication range of the source user equipment, wherein the primary relay user equipment and the first intermediate relay user equipment communicate via a first short-range communication link, and wherein the first intermediate relay user equipment and the destination user equipment communicate via a second short-range communication link;
transmitting, to the first intermediate relay user equipment, a first partial quality-of-service report request requesting at least one quality-of-service parameter metric corresponding to the second short-range communication link;
receiving, from the first intermediate relay user equipment, responsive to the first partial quality-of-service report request, a first partial quality-of-service report comprising a first metric indication indicative of a first quality-of-service metric corresponding to the second short-range communication link; and
transmitting, responsive to the end-to-end quality-of-service report request, to the source user equipment, an end-to-end quality-of-service report comprising a group quality-of-service metric indication that is indicative of a group quality-of-service corresponding to the remote group of user equipment and that is based on the first quality-of-service metric.

18. The non-transitory machine-readable medium of claim 17, wherein the remote group of user equipment comprises the first intermediate relay user equipment and a second intermediate relay user equipment, wherein the first intermediate relay user equipment and the second intermediate relay user equipment are communicatively linked via the second short-range communication link, wherein the second intermediate relay user equipment communicates with the destination user equipment via a third short-range communication link, wherein the first partial quality-of-service report comprises a second metric indication indicative of a second quality-of-service metric corresponding to the third short-range communication link, and wherein the group quality-of-service metric indication is based on the first quality-of-service metric and the second quality-of-service metric.

19. The non-transitory machine-readable medium of claim 18, wherein the first intermediate relay user equipment and the second intermediate relay user equipment compose a first relay subgroup of the remote group of user equipment, wherein the remote group of user equipment comprises a second relay subgroup comprising a third intermediate relay user equipment, wherein the second intermediate relay user equipment and the third intermediate relay user equipment are communicatively linked via the third short-range communication link, wherein the third intermediate relay user equipment is configured to communicate with the destination user equipment via a fourth short-range communication link, and wherein the operations further comprise:
transmitting, to the third intermediate relay user equipment, a second partial quality-of-service report request requesting at least one quality-of-service parameter metric corresponding to the second relay subgroup; and
receiving, from the third intermediate relay user equipment, responsive to the second partial quality-of-service report request, a second partial quality-of-service report comprising a third metric indication indicative of a third quality-of-service metric corresponding to the second relay subgroup,
wherein the group quality-of-service metric is based on the first quality-of-service metric, the second quality-of-service metric, and the third quality-of-service metric.

20. The non-transitory machine-readable medium of claim 19, wherein the first short-range communication link, the second short-range communication link, the third short-range communication link, or the fourth short-range communication link are respectively either a sidelink communication link or a Wi-Fi communication link.
